(19) United States
(12) Patent Application Publication
(10) Pub. No.: US 2008/0043472 A1
(43) Pub. Date: Feb. 21, 2008

(54) LED Lamp having a Heat Dissipating Structure

(76) Inventor: Chin-Wen Wang, Pingzhen City (TW)

Correspondence Address: HDSL, 4331 STEVENS BATTLE LANE, FAIRFAX, VA, 22033, US

(21) Appl. No.: 11/465,218

(22) Filed: Aug. 17, 2006

(51) Int. Cl. F21V 29/00

(52) U.S. Cl. 362/294

(57) ABSTRACT

An LED lamp having a heat dissipating structure for dissipating the heat of the LED lamp includes a lamp casing, an LED lamp module, an isothermal board and a heat pipe. The lamp casing has an opening, and the LED lamp module is fixed to a side of the opening of the lamp casing and includes a circuit board and a plurality of LED fixed on a plane of a circuit board, and another plane of the circuit board is attached on the isothermal board, and a circular groove is formed on the isothermal board. The heat pipe has a heat receiving end attached onto an internal surface of the groove of the isothermal board, so as to significantly enhance the heat conducting and dissipating effect and omit the manufacturing process of flattening a portion of the heat pipe to lower the manufacturing cost.

### BACKGROUND OF THE INVENTION

1. Field of the Invention

The present invention relates to an LED lamp having a heat dissipating structure, and more particularly to a heat dissipating structure for dissipating the heat of an LED lamp.

2. Description of Prior Art

Since light emitting diodes (LEDs) feature the advantages of high brightness, power saving and long life expectancy, LEDs have been used extensively for the illumination of lamps. Several LED bulbs are usually arranged and connected to a circuit board to form an LED lamp module. Since the LED lamp usually comes with poor heat resistance, therefore it generally requires heat conducting and dissipating components to conduct the heat produced by each LED lamp, and each LED lamp can be operated at a lower temperature. Thus, the LED lamp and heat dissipating components are indispensable to each other, and designing a structure for enhancing the overall heat conducting and dissipating effects becomes an important subject for manufacturers in the related industry.

A traditional LED lamp having a heat dissipating structure includes a lamp casing, an LED lamp module, a heat pipe and a heat dissipating body, wherein the LED lamp module is contained in the lamp casing, and a plurality of LEDs disposed at the bottom of the LED lamp module, and the back of the LED lamp module is attached onto a flat bottom surface of the heat pipe, and the heat dissipating body comprises a plurality of heat sinks stacked with each other and a corresponding interconnecting hole disposed thereon. The interconnecting hole is provided and sheathed onto another end of the heat pipe. If each LED emits light and produces heat, the heat can be conducted to each heat sink by the heat pipe, so that the heat can be dissipated from each heat sink to the outside. The assembly of the foregoing components constitutes an LED lamp having a heat dissipating structure.

However, the traditional LED lamps having a heat dissipating structure still have the following problems in actual applications. Since the traditional LED lamps require a process of flattening the bottom of the heat pipe to increase the contact area of the heat pipe with the LED lamp module, not only increasing the manufacturing cost of the heat pipe, but also causing a possible peel-off of capillary tissues and walls of the heat pipe and a loss of thermal conduction and greatly lowering the heat conducting and dissipating effects. Furthermore, the contact area of the heat pipe with the LED lamp is very limited, and thus the heat dispersion effect is poor, particularly for high power LED lamps. As a result, the current LED lamps cannot meet the heat dissipation requirements, and its low heat conducting and dissipating performance shortens the life expectancy of the LED lamps, and thus the prior art requires further improvements.

### SUMMARY OF THE INVENTION

In view of the foregoing shortcomings of the prior art, the inventor of the present invention based on years of experience in the related industry to conduct experiments and modifications, and finally designed an LED lamp having a heat dissipating structure in accordance with the present invention.

Therefore, the present invention is to provide an LED lamp having a heat dissipating structure that uses a large contact area between the isothermal board and the heat pipe to greatly increase the heat conducting and dissipating effect and also omit the manufacturing process of flattening a portion of the heat pipe to lower the manufacturing cost.

The present invention provides an LED lamp having a heat dissipating structure for dissipating the heat produced by the LED lamp, and the structure comprises a lamp casing, an LED lamp module, an isothermal board and a heat pipe. The lamp casing has an opening, and the LED lamp module is fixed to a side of the opening of the lamp casing and includes a circuit board and a plurality of LEDs fixed on a plane of a circuit board, and another plane of the circuit board is attached on the isothermal board, and a circular groove is formed on the isothermal board. The heat pipe has a heat receiving end attached onto an internal surface of the groove of the isothermal board.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an exploded view of the present invention;

FIG. 2 is a schematic view of a portion of an assembly of the present invention;

FIG. 3 is a perspective view of an assembly of the present invention; and

FIG. 4 is a cross-sectional view of an assembly of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

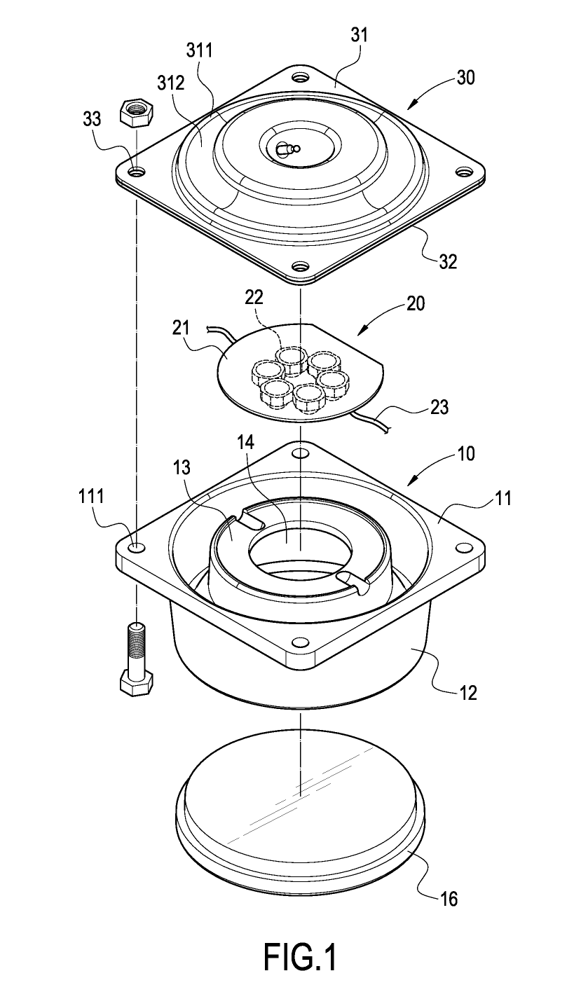

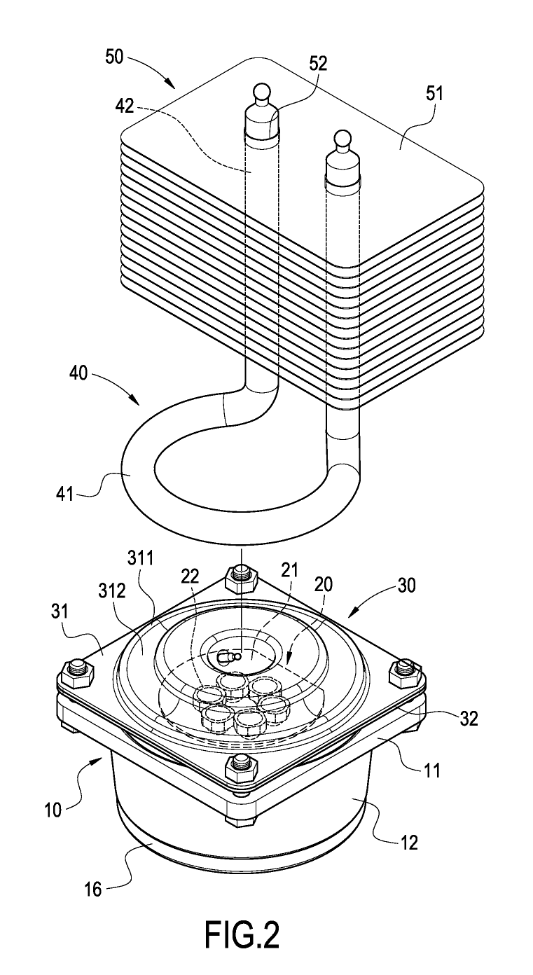

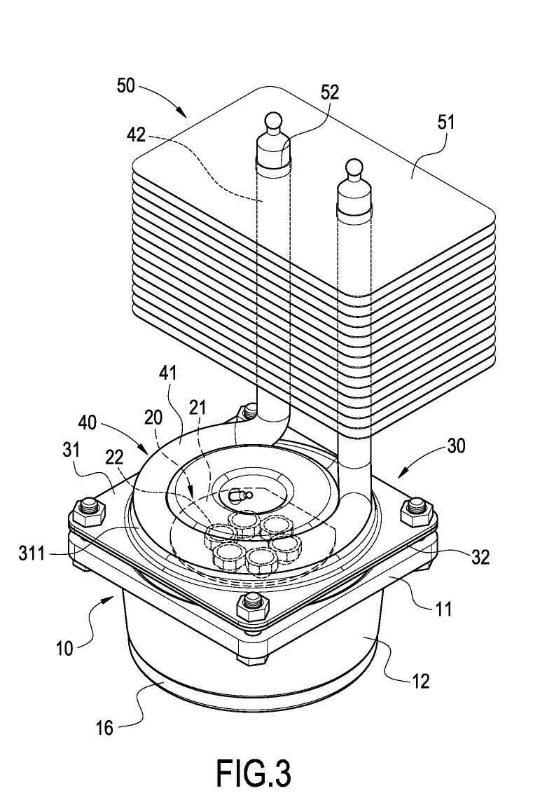

Referring to FIGS. 1 to 4 for an exploded view, a schematic view, a perspective view and a cross-sectional view of the present invention, the invention provides an LED lamp having a heat dissipating structure that comprises a lamp casing 10, an LED lamp module 20, an isothermal board 30 and a heat pipe 40 (as shown in FIG. 2).

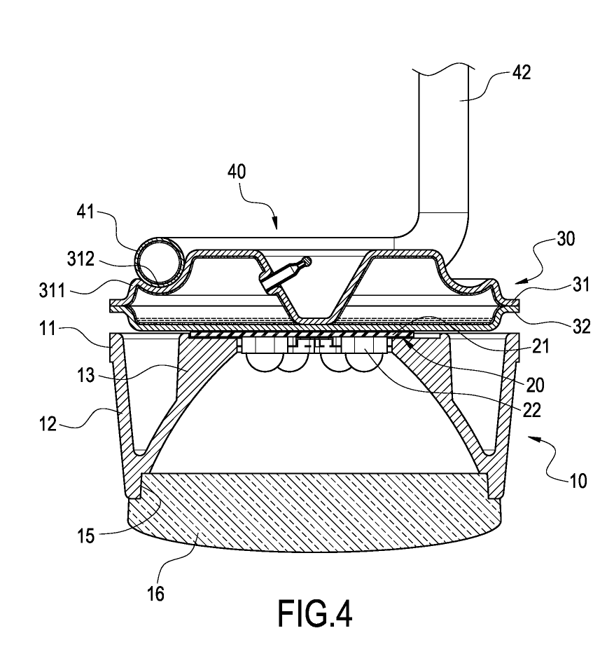

The lamp casing 10 includes a rectangular fixing base 11, a through hole 111 disposed separately at four corners of the fixing base 11, a circular external cover 12 extended downward from the bottom surface of the fixing base 11, a bowl-shape internal cover 13 formed on an internal side of the external cover 12, an opening 14 formed at the top surface of the internal cover 13, and a fixing ring 15 formed at an internal side of the bottom of the internal cover 13 fixing ring 15 for connecting a light transmitting lens 16 (as shown in FIG. 4).

The LED lamp module 20 is fixed on a side of the opening 14 of the lamp casing 10 and includes a circuit board 21 and a plurality of LEDs 22 fixed onto the bottom surface of the circuit board 21, and a power cable 23 disposed on the circuit board 21 and electrically connected to the LEDs 22. The bottom surface of the circuit board 21 is attached onto the top surface of the internal cover 13, and each LED 22 is contained in the internal cover 13.

The bottom surface of the isothermal board 30 is attached onto the top surface of the circuit board 21 of the LED lamp module 20, and the isothermal board 30 includes an upper casing plate 31 and a corresponding lower casing plate 32 engaged with the bottom of the upper casing plate 31. A vacuum chamber is formed between the upper and lower casing plates 31, 32, and capillary tissues and operating fluids are filled into the vacuum chamber, and the fluid phased thermal conduction mechanism is used to achieve a quick thermal conduction effect. Further, a stairway-like circular surrounding plate 311 is extended upward from the center of the upper casing plate 31, and an arc groove 312 is formed on the surrounding plate 311, and a penetrating hole 33 is disposed separately at four corners of the isothermal board 30 and corresponding to the through hole 111 of the lamp casing 10 for passing and securing a fixing element such as a screw bolt.

The heat pipe 40 includes a circular heat receiving end 41 and two heat discharging ends 42 extended vertically upward from the distal ends of the heat receiving end 41, and the heat receiving end 41 is attached onto an internal surface of the groove 312 of the isothermal board 30.

The present invention further includes a heat dissipating body 50 comprised of a plurality of heat sinks 51 stacked with each other, a corresponding interconnecting hole 52 disposed on each heat sink 51 for passing and connecting a heat discharging end 42 of the heat pipe 40.

In the assembling process, the circuit board 21 of the LED lamp module 20 is installed on the top of the internal cover 13 of the lamp casing 10 and then each penetrating hole 33 of the isothermal board 30 corresponds to the through hole 111 of the fixing base 11, and then a screw bolt is passed sequentially through the through hole 111 and the penetrating hole 33 and secured with a screw nut, so that the bottom surface of the lower casing plate 32 of the isothermal board 30 is attached onto the top surface of the circuit board 21. Further, the interconnecting hole 52 of the heat dissipating body 50 is sheathed onto the heat discharging end 42 of the heat pipe 40, and then a lower arc surface of the heat receiving end 41 of the heat pipe 40 is attached to the internal surface of the groove 312 of the isothermal board 30, and a thermal conducting medium can be coated between the heat receiving end 41 and the groove 312 to improve the heat conducting effect. Finally, glue is applied onto the fixing ring 15 at the internal cover 13, and then the light transmitting lens 16 is connected to form an LED lamp.

During the use of an LED lamp, a current is passed into the LED lamp module 20, such that each LED 22 emits light and produces heat, and the heat is conducted to the circuit board 21. With the large contact area between the circuit board 21 and the isothermal board 30 and the fluid phased thermal conduction mechanism of the isothermal board 30, the heat is dispersed rapidly to the heat receiving end 41 of the heat pipe 40 and conducted to the heat discharging end 42 for a heat exchange with each heat sink 51. Finally, the low-temperature airflow outside the LED lamp can carry away the heat of each heat sink 51, such that each LED 22 can be operated at a lower temperature, so as to extend the life expectancy of the LED 22.

In view of the foregoing structure, the present invention uses a large contact area between the isothermal board 30 and the heat pipe 40 to greatly improve the heat conducting and dissipating effects and omit the manufacturing process of flattening a portion of the heat pipe 40 to lower the manufacturing cost.

In summation of the above description, the LED lamp having a heat dissipating structure in accordance with the invention herein enhances the performance than the conventional structure and further complies with the patent application requirements.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An LED lamp having a heat dissipating structure, comprising:
a lamp casing, having an opening;
an LED lamp module, fixed at one side of the opening of the lamp casing, and having a circuit board and a plurality of LED fixed onto one plane of the circuit board;
an isothermal board, attached onto the other plane of the circuit board of the LED lamp module, and forming a circular groove thereon; and
a heat pipe, having a heat receiving end attached onto an internal surface of a groove of the isothermal board.

2. The LED lamp having a heat dissipating structure of claim 1, wherein the lamp casing includes a fixing base, a through hole disposed separately at four corners of the fixing base, and a penetrating hole disposed separately at four corners of the isothermal board and corresponding to the through hole, for passing and securing a fixing element.

3. The LED lamp having a heat dissipating structure of claim 2, wherein the fixing base includes an external cover extended downward from the bottom of the fixing base, an internal cover formed on an internal side of the external cover, and an opening formed at a top surface of the internal cover.

4. The LED lamp having a heat dissipating structure of claim 3, wherein the internal cover forms a fixing ring at a bottom of the internal cover, for connecting a light transmitting lens.

5. The LED lamp having a heat dissipating structure of claim 1, wherein the isothermal board includes an upper casing plate, a lower casing plate engaged with the corresponding upper casing plate, a surrounding plate extended upward from the upper casing plate, and a groove formed on the surrounding plate.

6. The LED lamp having a heat dissipating structure of claim 1, wherein the heat receiving end of the heat pipe is in shape of a horizontal ring, and a heat discharging end is extended vertically upward from a distal end of the heat receiving end.

7. The LED lamp having a heat dissipating structure of claim 6, further comprising a heat dissipating body sheathed onto a heat discharging end of the heat pipe.

8. The LED lamp having a heat dissipating structure of claim 7, wherein the heat dissipating body includes a plurality of heat sinks stacked with each other.
